(19) United States
(12) Patent Application Publication
(10) Pub. No.: US 2010/0305798 A1
(43) Pub. Date: Dec. 2, 2010

(54) System And Method For Vehicle Drive Cycle Determination And Energy Management

(75) Inventors: Anthony Mark Phillips, Northville, MI (US); Ming Lang Kuang, Canton, MI (US); JungMe Park, Novi, MI (US); Yi Murphey, Ann Arbor, MI (US); Leonidas Kiliaris, Lincoln Park, MI (US); Md Abul Masrur, West Bloomfield, MI (US); Zhihang Chen, Windsor (CA)

Correspondence Address: BROOKS KUSHMAN P.C./FGTL, 1000 TOWN CENTER, 22ND FLOOR, SOUTHFIELD, MI, 48075-1238, US

(73) Assignees: FORD GLOBAL TECHNOLOGIES, LLC, Dearborn, MI (US); Government of the United States as Represented by the Secretart of the Army, Arlington, VA (US); The Regents of the University of Michigan, Ann Arbor, MI (US)

(21) Appl. No.: 12/788,819

(22) Filed: May 27, 2010

Related U.S. Application Data
(60) Provisional application No. 61/182,326, filed on May 29, 2009.

(51) Int. Cl. G06F 19/00

(52) U.S. Cl. 701/22; 180/65.21

(57) ABSTRACT

System and method for vehicle drive cycle determination and energy management is provided. Based on a number of inputs, the system can determine the type of road that the vehicle is likely to drive on as well as the level of traffic congestion that the vehicle is likely to experience. Using these determinations, setpoints for various degrees of freedom, such as engine speed and battery power, can be set to reduce energy usage in the vehicle.

### CROSS-REFERENCE TO RELATED APPLICATION

This application claims the benefit of the U.S. Provisional Application filed May 29, 2009, and having Application No. 61/182,326, the entire disclosure of which is incorporated by reference herein.

### STATEMENT REGARDING FEDERALLY SPONSORED RESEARCH OR DEVELOPMENT

This invention was made with U.S. Government support. The U.S. Government has certain rights in this invention.

### BACKGROUND

1. Technical Field

System and method for vehicle drive cycle determination and energy management.

2. Background Art

The need to reduce energy usage in a vehicle is well known. Various energy management systems have been developed for vehicles. Many of the energy management systems involve determining one or more setpoints for each available degree of freedom in a vehicle based on fixed constraints. One degree of freedom can be battery power request. Another degree of freedom can be engine speed. A hybrid vehicle may have two or three degrees of freedom, depending on the configuration of the energy management system in the hybrid vehicle. Thus, the hybrid vehicle may have both battery power request and engine speed as the two degrees of freedom.

Many energy management systems try to set the degrees of freedom in an effort to achieve the best possible fuel economy. Setting the degrees of freedom can be based on a number of informational inputs. However, collecting all information needed to achieve optimal fuel economy is impossible because it is impossible to know exactly how the driver will be driving the vehicle in the future. In addition, it is impossible to know the exact environmental conditions (e.g., traffic, weather, travel route) that the vehicle will experience. Consequently, the setpoints that an energy management system sets for the each of the degrees of freedom may not be optimal for achieving the best possible fuel economy or the best energy usage for a given power demand.

Driving patterns exhibited by a human driver are the product of the instantaneous decisions of the driver to cope with the (physical) driving environment. Research has shown that driving style and environment influence fuel consumption and emissions of the vehicle [Eri00, Eri01]. For example, road type and traffic conditions, driving trend, driving style, and vehicle operation modes can impact the fuel consumption of the vehicle. However, many vehicle power control approaches do not incorporate the knowledge about driving patterns into their vehicle power management strategies.

One or more of the following references may be referenced herein:
[1] E. Ericsson, “Variability in urban driving patterns,” Transportation Res. Part D, vol. 5, pp. 337-354, 2000.
[2] E. Ericsson, “Independent driving pattern factors and their influence on fuel-use and exhaust emission factors,” Transport. Res. Part D, vol. 6, pp. 325-341, 2001.
[3] S.-I. Jeon, S.-T. Jo, Y.-I. Park, and J.-M. Lee, “Multi-mode driving control of a parallel hybrid electric vehicle using driving pattern recognition,” J. Dyn. Syst., Measure. Contr., vol. 124, pp. 141-149, March 2002.
[4] I. Kolmanovsky, I. Siverguina, and B. Lygoe, “Optimization of powertrain operating policy for feasibility assessment and calibration: stochastic dynamic programming approach,” in Proc. Amer. Contr. Conf., vol. 2, Anchorage, Ak., May 2002, pp. 1425-1430.
[5] Langari, R.; Jong-Seob Won, “Intelligent energy management agent for a parallel hybrid vehicle-part I: system architecture and design of the driving situation identification process,” IEEE Transactions on Vehicular Technology, volume 54, issue 3, Page(s):925-934, 2005.
[6] Jong-Seob Won; Langari, R., “Intelligent energy management agent for a parallel hybrid vehicle-part II: torque distribution, charge sustenance strategies, and performance results,” IEEE Transactions on Vehicular Technology, volume 54, issue 3, Page(s):935-953, 2005.
[7] Yi L. Murphey, “Intelligent Vehicle Power Management—an overview” a chapter in the book “Computational Intelligence in Automotive Applications” to be published by Springer 2008
[8] T. R. Carlson and R. C. Austin, “Development of speed correction cycles,” Sierra Research, Inc., Sacramento, Calif., Report SR97-04-01, 1997.
[9] Sierra Research, “SCF Improvement—Cycle Development,” Sierra Report No. SR2003-06-02, 2003.
[10] Highway Capacity Manual 2000, Transportation Res. Board, Wash., DC, 2000
[11] F. Ferri, P. Pudil, M. hatef, and J. Kittler, “Comparative Study of Techniques for Large Scale Feature Selection,” Pattern Recognition in Practice IV, E. Gelsema and L. Kanal, eds., pp. 403-413. Elsevier Science B. V. 1994.
[12] Yi Lu Murphey and Hong Guo “Automatic Feature Selection—a hybrid statistical approach,” International Conference on Pattern Recognition, Barcelona, Spain, Sep. 3-8, 2000.
[13] Jacob A. Crossman, Hong Guo, Yi Lu Murphey, and John Cardillo, “Automotive Signal Fault Diagnostics: Part I: signal fault analysis, feature extraction, and quasi optimal signal selection,” IEEE Transactions on Vehicular Technology, July 2003.
[14] Guobin Ou and Yi Lu Murphey, “Multi-class Pattern Classification Using Neural Networks,” Journal of Pattern Recognition, Vol. 40, Issue 1, Pages 4-18, January 2007.
[15] C.-C. Lin, H. Peng, J. W. Grizzle, and J.-M. Kang, “Power management strategy for a parallel hybrid electric truck,” IEEE Trans. Contr. Syst. Technol., vol. 11, no. 6, pp. 839-849, November 2003.
[16] Koot, M.; Kessels, J. T. B. A.; de Jager, B.; Heemels, W. P. M. H.; van den Bosch, P. P. J.; Steinbuch, M., Energy management strategies for vehicular electric power systems, IEEE Transactions on Vehicular Technology, Volume 54, Issue 3, Page(s):771-782, May 2005.

### SUMMARY

A system and method is provided for vehicle drive cycle determination and energy control for an automotive vehicle with an engine and a storage battery.

The system includes a computer-readable storage medium and a controller. The controller is in electrical communication with the storage medium and is configured to receive and process a speed signal. The speed signal represents speed of the vehicle. The controller processes the speed signal to obtain a set of features characterizing a driving environment that the vehicle has experienced. The driving environment may include at least one road type that the vehicle has traversed. In addition, the driving environment may include at least one level of traffic congestion that the vehicle has experienced.

The controller processes the features to determine a drive cycle. In addition, the controller generates a control signal based on the drive cycle. The control signal is used to control charging of the storage battery with power generated from the engine. The control signal may control a rate of charging of the storage battery. Furthermore, the control signal may control when to charge the storage battery. The control signal may be generated in an effort to decrease energy usage in the automotive vehicle.

### BRIEF DESCRIPTION OF THE DRAWINGS

FIG. 1 is a graph illustrating a speed profile having first, second, and third time segments with the second time segment partially overlapping the first and third time segments;

FIG. 2 is a bar graph illustrating training accuracies for various window sizes and time steps;

FIG. 3 is a bar graph illustrating prediction accuracies for various window sizes and time steps;

FIG. 4 is a graph illustrating a labeled driving cycle;

FIG. 5 is a schematic diagram illustrating a system for vehicle drive cycle determination and energy management;

FIG. 6 is a graph illustrating state of charge of a battery over time during an Urban Dynamometer Driving Schedule (UDDS) drive cycle;

FIG. 7 is a graph illustrating state of charge of a battery over time during a UNIF01 drive cycle; and

FIG. 8 is a graph illustrating state of charge of a battery over time during a LA92 drive cycle.

### DETAILED DESCRIPTION

Embodiments of the present invention generally provide a system and method for vehicle drive cycle determination and energy management. Determining the drive cycle of a vehicle can be based on a number of inputs. Once the drive cycle of the vehicle is determined, energy within the vehicle can be controlled. For example, the degree of freedom setpoints may be controlled based on the drive cycle determination in an effort to optimize fuel economy in the vehicle. The system and its method of operation are described in an integrated manner to facilitate understanding of various aspects of the present invention.

To determine the drive cycle of the vehicle, the system can predict the type of road that the vehicle is expected to drive on as well as the level of traffic congestion that the vehicle is expected to experience. Once a road type is identified, it is assumed that the vehicle will continue on that road type for some time after the prediction. This information can then be used as part of an overall energy management strategy to better position the setpoints for the degrees of freedom within the vehicle. The prediction strategy may use a neural network to receive vehicle speed and other related signals in to the algorithm as inputs and to return the predicted road type.

One advantage of the system and method is the availability of predictive drive cycle information to improve energy management. Predicted fuel economy improvements (in simulation) using this drive cycle information on a conventional vehicle have resulted in a fuel economy increase of over 2.5%. Such an increase in fuel economy may be greater for a hybrid vehicle, such as a hybrid electric vehicle (HEV).

The system may be an intelligent system that can accurately predict the driving patterns in the near future. The system may include a neural network system. The neural network system predicts road type and traffic congestions. The system may determine the road environment of a driving trip, select features that effectively characterize road type and traffic congestion levels, and train the neural network based on online prediction of road type and traffic congestion level in the near future during a driving trip.

Section II presents an intelligent system model for the prediction of road type and traffic congestion level. Section III presents the neural network. Section IV presents the intelligent vehicle power management system that uses the neural network for online road prediction and its performances on three standard driving cycles.

### II. Predicting Roadtype and Traffic Congestion Level

The system may determine the road environment of a driving trip as a sequence of different road types such as local, freeway, arterial/collector, etc. augmented with different traffic congestion levels.

Under a contract with the Environmental Protection Agency (EPA), Sierra Research Inc. developed a set of 11 standard drive cycles, called facility-specific (FS) cycles, to represent passenger car and light truck operations over a range of facilities and congestion levels in urban areas [CaA97, Sie03]. The 11 drive cycles can be divided into four categories, freeway, freeway ramp, arterial, and local. More recently, Sierra Research has updated the data to reflect the speed limit changes in the freeway category. The two categories, freeway and arterial are further divided into subcategories based on a qualitative measure called level of service (LOS) that describe operational conditions within a traffic stream based on speed and travel time, freedom to maneuver, traffic interruptions, comfort, and convenience. Six types of LOS are defined with labels, A through F. LOS A represents the best operating conditions and LOS F represents the worst. Each level of service represents a range of operating conditions and the driver's perception of those conditions [TRB00, Sie03].

TABLE I
STATISTICS OF 11 FACILITY SPECIFIC DRIVING CYCLES
Facility Cycles by Sierra Research

| | V_{avg} | Vₘₐₓ | Aₘₐₓ | Length |
|---|---|---|---|---|
| Cycle | (mph) | (mph) | (mph/s²) | (sec) |
| Freeway LOS A: R[1] | 67.79 | 79.52 | 2.3 | 399 |
| Freeway LOS B: R[2] | 66.91 | 78.34 | 2.9 | 366 |
| Freeway LOS C: R[3] | 66.54 | 78.74 | 3.4 | 448 |
| Freeway LOS D: R[4] | 65.25 | 77.56 | 2.9 | 433 |
| Freeway LOS E: R[5] | 57.2 | 74.43 | 4.0 | 471 |
| Freeway LOS F: R[6] | 32.63 | 63.85 | 4.0 | 536 |
| Freeway Ramps: R[7] | 34.6 | 60.2 | 5.7 | 266 |
| Arterials LOS A-B: R[8] | 24.8 | 58.9 | 5.0 | 737 |
| Arterials LOS C-D: R[9] | 19.2 | 49.5 | 5.7 | 629 |
| Arterials LOS E-F: R[10] | 11.6 | 39.9 | 5.8 | 504 |
| Local Roadways: R[11] | 12.9 | 38.3 | 3.7 | 525 |

As shown in Table 1 above, the 11 classes of road types and congestion level are labelled as R[1], R[2], R[3], R[4], R[5], R[6], R[7], R[8], R[9], R[10], and R[11] along with definitions of these road types [Sie03]. The problem of road type prediction may be formulated as follows. Let SP[t] be the speed profile of a driver on the road, t=0, 1, . . . , t_{c}, where t_{c} is the current time instance, and RT[t] be the road types the driver needs to go through to complete his trip, where 0<t<tₑ, tₑ is the time when the trip ended. At any given time t_{c}, RT(t_{c}) ε{R[i]|i=1, . . . , 11}. The road type in the near future can be predicted based on the short term history of the driver during the trip.

Specifically, a non-linear function F may be developed such that F(SP(t)|t ε[(t_{c}−ω),t_{c}])=R[j], 0<j≦11, where ω>0 is called window size that characterizes the length of the speed profile that should be used to explore driving patterns. The variable R[j] represents the road type the driver will be on during the time interval [t_{c}, (t_{c}+Δt)], i.e. RT[t]=R[j] for t ε[t_{c}, (t_{c}+Δt)]. Δt >1 may be referred to as the time step. To solve this problem, four different aspects of the road type predictor can be determined:
select effective features that can be extracted from SP(t), t_{c}−ω<t≦t_{c} for the prediction of the current road type.
determine the optimal window size ω
determine the optimal time step Δt
develop a function F that has the capability of accurately predicting road types in sufficiently short time suitable for online driving prediction. Function F is obtained in a neural network described in the next section.

### III. Developing a Neural Network to Predict Road Types and Traffic Congestion Levels

In this section, the four aspects for predicting road type and traffic congestion level are described.

### A. Feature Selection

Road types and traffic congestion levels can be observed generally in the speed profile of the vehicle. The statistics used to characterize driving patterns include 16 groups of parameters (62 total) suggested by the Sierra Research, and parameters in 9 out of these 16 groups affect fuel usage and emissions. However, it may not be necessary to use all these features for predicting a specific drive pattern, and, additionally new features may be explored as well. For example in [LaW05], Langari and Won used only 40 of the 62 parameters and then added seven new parameters: trip time, trip distance, maximum speed; maximum acceleration; maximum deceleration; number of stops, idle time (percent of time at speed 0 km/h). However, the use of additional parameters needs to be balanced with the “curse of dimensionality”: too many features may degrade system performance. Furthermore, in onboard vehicle implementation more features imply higher hardware cost and/or more computational time. Because the feature selection problem is computationally expensive, research has focused on finding a quasi optimal subset of features, where quasi optimal implies good classification performance, but not necessarily the best classification performance. Interesting feature selection techniques can be found in [FPH94, MuG00, CGM03]. However most of these feature selection algorithms were developed for 2-class classification problem, and extensions to K-class (K>2) will significantly increase the computational time. With this in mind, the following feature selection algorithm based on road type can be developed.

### Feature Selection Method/Algorithm

Step 1: Let X be the training data set, and ω be the initial set of n features, which can be obtained from those suggested by the research community as discussed above.

Step 2: Re-labeling data in X with freeway samples as “1” and all others as “0”. Denote this training data set as X1. Select the best features from ω that can classify all the freeway data against all other data in X1. Denote this feature set as F1.

Step 3: Re-labeling data in X with freeway ramp samples as “1” and all others as “0”. Denote this training data set as X2. Select the best features from ω that are NOT in F1 and that can classify all the freeway Ramp data against all other data in X2. Denote this feature set as F2.

Step 4: Re-labeling data in X with Arterial data samples as “1” and all others as “0”. Denote this training data set as X3. Select the features that are NOT in F1∪F2 and can best classify all the Arterial data against all other data in X3. Denote this feature set as F3.

Step 5: Re-labeling data in X with local road data samples as “1” and all others as “0”. Denote this training data set as X4. Select the features that are NOT in F1∪F2∪F3 and can best classify all the local road data against all others in X4. Denote this feature set as F4.

Step 6: Output feature set F=F1∪F2∪F3∪F4

When the algorithm described above is applied to an initial set (ω) of 47 features suggested by Langari and Won in [LaW05], the set (F) of 14 features shown in Table II can be obtained.

TABLE II
14 FEATURES SELECTED FOR ROAD TYPE PREDICTION

Name of selected features:
Trip distance;
Maximum speed;
Maximum acceleration;
Maximum deceleration
Average speed
Average acceleration
S. D. of acceleration
Average deceleration
% of time in speed interval 0-15 km/h
% of time in speed interval 15-30 km/h
% of time in speed interval >110 km/h
% of time in deceleration interval (−10)-(−2.5) m/s2
% of time in deceleration interval (−2.5)-(−1.5) m/s2
Number of acceleration/deceleration shifts per 100 m where
the difference between adjacent local max-speed and min-
speed was >2 km/h

### B. Optimal Window Size and Time Step in Online Predicting

Since the system can be used to predict the road type in the near future, the driving speed in the last segment, [t_{c}−Δw, t_{c}], where t_{c} is the current time, is used to predict the road type the driver is on during time period, [t_{c}, t_{c}+Δt]. The prediction is made at time steps, kΔt, k=1, 2, . . . . The window size of the speed profile segments is Δw, where Δw>0. The time interval over which the prediction is made is Δt.

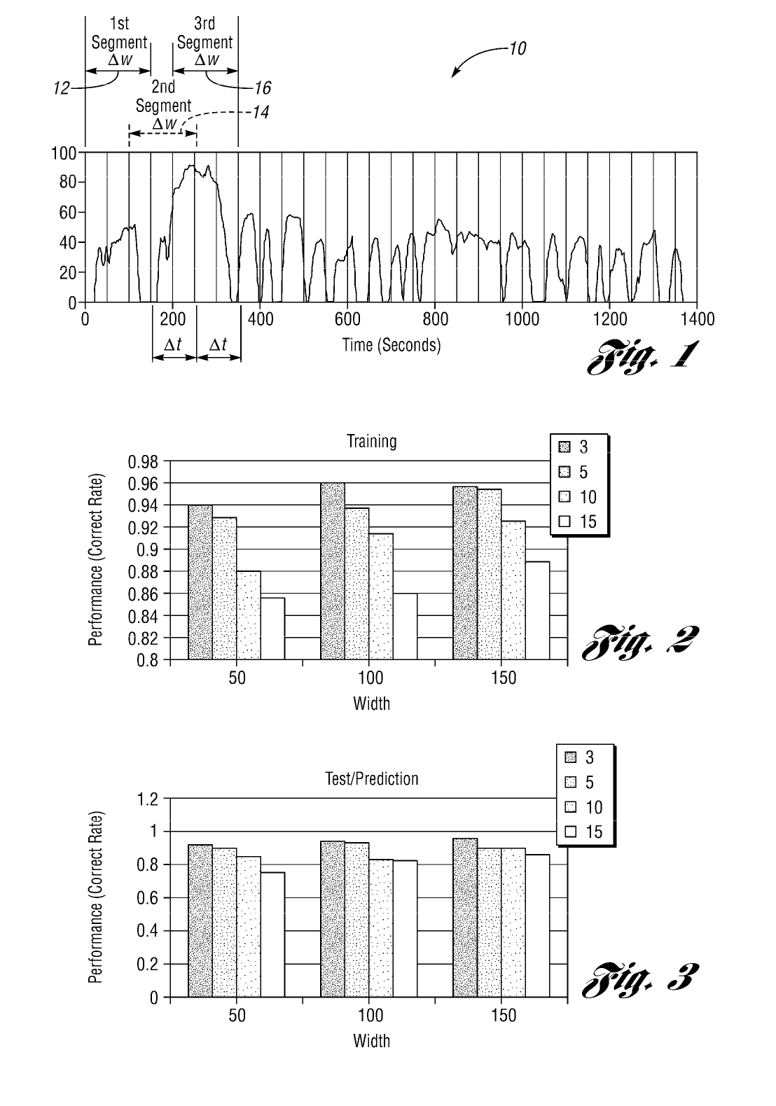

FIG. 1 illustrates Δw and Δt on the speed profile of the UDDS drive cycle. The x-axis represents the time during a driving cycle and y-axis represents the vehicle speed in meters per second. The segments shown have the equal size of Δw=150 seconds and the time step, Δt=100 seconds. Please note that Δt=100 seconds is chosen here for the clarity of illustrating FIG. 1. Δt can be smaller than 100 seconds. The two parameters are important for the accuracy of prediction. Since features characterizing road types are extracted from the speed profile of the vehicle in the time interval [t_{c}−Δw, t_{c}], if Δw is too small, the segment may be too small to contain useful information. If Δw is too big, the segment may contain obsolete information. Once Δw is determined, the 14 features presented in Table 2 are extracted from the speed profile within the time interval [t_{c}−Δw, t_{c}] and used as the input feature vector to the neural network described in the next section. The time step Δt also needs to be properly determined. If Δt is too short, it would imply that the prediction routine would run often. If it is too long, the road type may change during the near future horizon, [t_{c}, t_{c}+Δt].

The optimal window size and optimal time step are determined through a series of experiments by varying Δw in a reasonable range such as 30, 50, 100, 150, and Δt=3 seconds, 5 seconds, 10 seconds, 15 seconds. For every pair of window size and time step, a neural network system is trained (see detail in the next section) and tested on data sets extracted from the 11 drive cycles provided in the PSAT library.

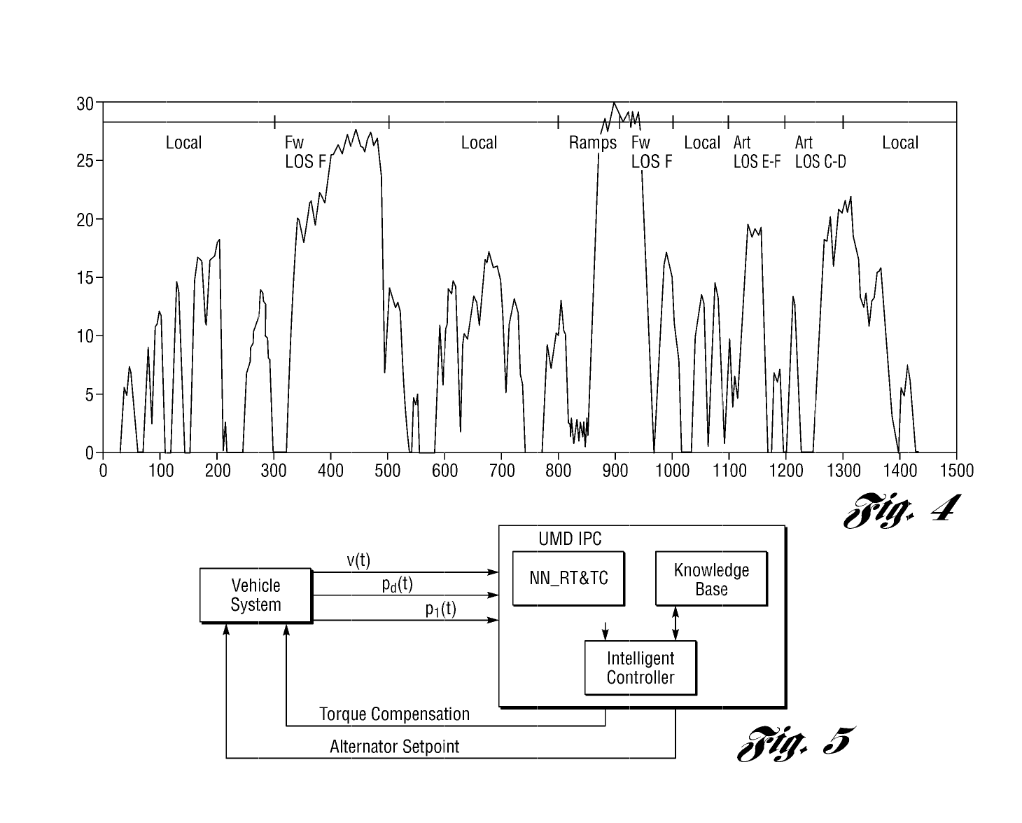

FIGS. 2-3 show the results of this experiment. Based on the analysis of the performances on both the training and test data, it appears that the performances between Δw=100 seconds and Δw=150 are very close, so either one should work well. It appears that Δt=3 seconds since this time step works well on all window sizes. However, Δt=1 and 2 seconds can work as well. Since Δt=3 implies less frequent prediction, this is the time step selected in this case.

### C. Training a Neural Network to Predict Road Types

A multi-layered, multi-class neural network, NN_RT&TC, can be developed for the prediction of road types and traffic congestion levels. The training data can be obtained as follow. All 11 PSAT drive cycles, UDDS, HWFET, US06, SCO3, LA92, IM240, Rep05, NY City, HL07, Unif01, Arb02 can be segmented and labeled for use as training and test data. The simulation software, PSAT (Powertrain System Analysis Toolkit) is a “forward-looking” model that can simulate fuel economy and performance in a realistic manner—taking into account transient behavior and control system characteristics. PSAT can simulate a number of predefined configurations (conventional, electric, fuel cell, series hybrid, parallel hybrid, and power split hybrid). PSAT software can be used to simulate all facility specific drive cycles to generate numerical data such as fuel consumption and emissions, and vehicle performance, etc. Each of the 11 PSAT drive cycles can be considered as a composite of the 11 classes of road types and traffic congestion levels.

FIG. 4 shows an example of a labeled drive cycle, LA92 segmented according to the definition of the 11 classes as defined by Sierra Research. The X axis indicates the time and the Y axis indicates the speed in meters/second.

For a window size of Δw, time step of Δt, and a driving cycle DC(t) (0≦t≦tₑ), DC segments on intervals can be generated, s₀=[t₀, Δw), . . . , sₖ=[k Δt, Δw+k Δt), . . . sₖₑ=[tₑ−Δw, tₑ], where k≧1.

From the speed function of each segment, a vector of the 14 features specified in Table I can be extracted. The feature vectors are randomly sampled into training and test data with a ratio of 4:1. For example, for Δw=50 seconds, Δt=3 seconds, a training data set of 2758 data samples and a test set of 689 data samples can be obtained. The feature vector extracted from every speed signal segment is labeled by the road type of its next segment since the prediction function is being trained.

A multi-class neural network, NN_RT&TC, of 14 input nodes and 11 output nodes with a hidden layer of 20 nodes has been trained for the road type prediction. The output nodes correspond to the 11 class labels, {R[1], . . . , R[11]}. The neural network is trained using the one-against-all scheme [OuM07].

Based on the results presented in the last section, Δw=150 seconds and Δt=3 seconds can be used. The training and test data are generated from 11 Sierra data and 11 PSAT driving cycles. There are totally 4399 segments generated from these 22 driving cycles. From each segment a vector of 14 features (see Table 2) is extracted. The separation of training and test data is through a random stratified sampling procedure. As the result the training data contain 3777 feature vectors and the test data contain 622 feature vectors. The performance of the neural network is 95.87% on the training data and 95.18% on the test data. When NN_RT&TC is used inside a vehicle to predict the road type at time t_{c}, the vector of the 14 features is extracted from the vehicle speed during the time interval, [t_{c-150} seconds, t_{c}]. The output from NN_RT&TC is the road type to be used by an intelligent vehicle power management to produce the optimal power distribution during time interval [t_{c}, t_{c}+3 seconds]. Its online performance is discussed in the next section.

### IV. Application in Vehicle Power Management

The neural network described in section III, NN_RT&TC, has been fully integrated into an intelligent vehicle power management system, UMD_IPC. FIG. 5 shows the components of the system. The vehicle system sends signals at time t such as the vehicle speed, v(t), the power required at the driveline, p_{d}(t), and the power required by the electric loads, pₗ(t) to the UMD_IPC. The UMD_IPC includes three components: NN_RT&TC, Knowledge Base, and Intelligent Controller.

The NN_RT&TC is the neural network presented in the last section. The knowledge base contains the knowledge about the optimal alternator setpoint and torque compensation learned from the 11 Sierra drive cycles. Based on the prediction of the road type and traffic congestion level made by NN_RT&TC, vehicle system information, and the stored knowledge related to the predicted road type, the Intelligent Controller outputs the optimal setting of torque compensation and alternator setpoint for the vehicle system to use during time interval, [t, t+Δt].

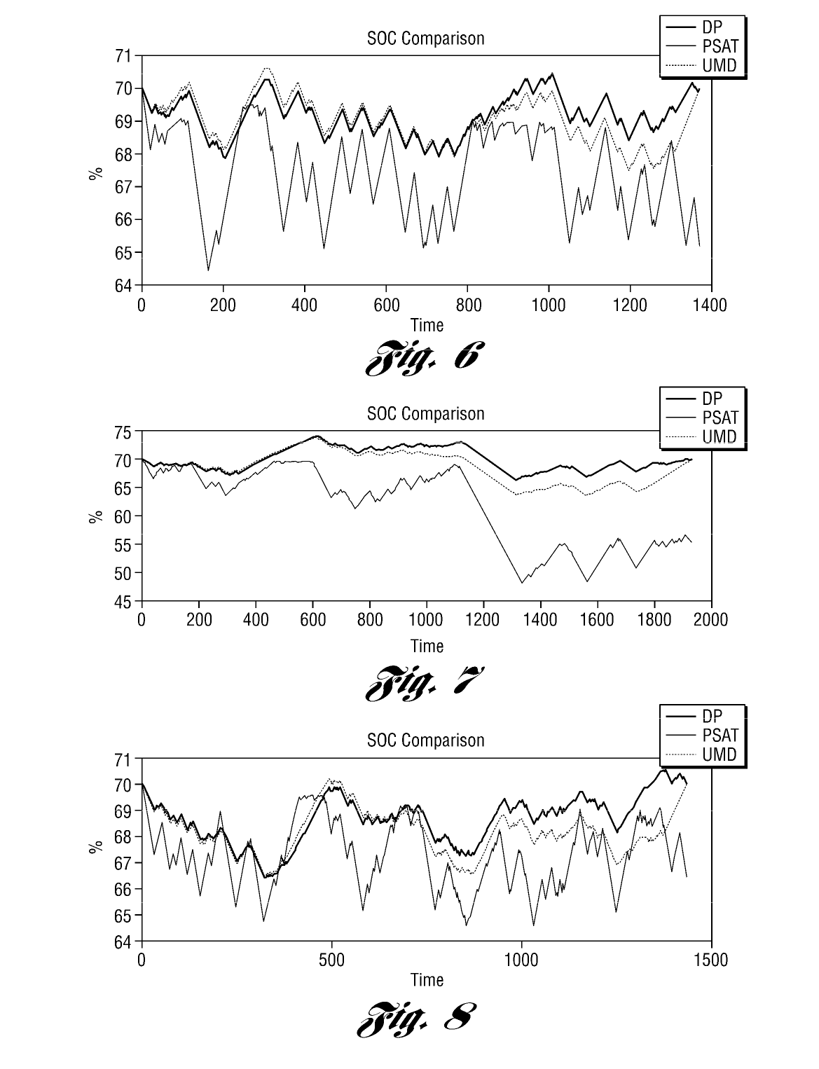

The UMD_IPC can be simulated using a conventional vehicle model in the PSAT software. The vehicle model is Ford Mondeo with a 95 KW 1.9 L Liter Spark Ignition engine, 5 gear manual transmission and a 12-14V 1.5 KW alternator, and a 66 Ah/12V lead acid battery. Experimental results for three driving cycles, UDDS, LA92 and UNIF01, are shown in FIG. 6-8 and Table 3. UDDS (Urban Dynamometer Driving Schedule) is also sometimes called FTP72. The cycle represents city driving conditions in a urban area with frequent stops. LA92 (also called Unified cycle) can be constructed of segments of actual driving recording in Los Angeles. It is a more aggressive driving cycle than the FTP (Federal Test Procedure). It has higher speeds, higher accelerations, fewer stops per mile, and less idle time. The UNIF01 Cycle was developed by Sierra Research for the California Air Resources Board and is a modified form of the LA92. For the purpose of comparison, off-line Dynamic Programming (DP) can be used to find the optimal operating points [LPG03, KKJ05]. Since the DP algorithm requires full knowledge of the entire driving cycle to optimize the power management strategy, it is not applicable to online control. However the results generated by DP can be used as a benchmark for the performance of power control strategies.

As illustrated in FIGS. 6-8, the battery state of charge (SOC) can have three different drive cycles using three different drive cycle prediction and control algorithms. The bolded line labeled “DP” in the plots show the SOC when DP is used for optimal prediction and control (with full drive cycle knowledge). The lines labeled “PSAT” show the SOC generated using the existing PSAT control strategy with no drive cycle prediction. Finally, the dotted lines labeled “UMD” show the results when the UMD_IPC prediction and control routine is used as described above.

The SOC curves generated by the UMD_IPC for each drive cycle have similar behavior to the respective ones generated by the offline DP algorithm. The SOC curves generated by the PSAT controller, on the other hand, are significantly different from the optimal curves.

Table III presents the performance comparison with respect to fuel consumption. The fuel consumed by the simulation vehicle with the conventional PSAT power management controller can be used as the baseline. For the UDDS and LA 92 drive cycles, the UMD_IPC gives almost identical fuel consumption as the optimal (DP) controller. On the UNIF01 drive cycle, the UMD_IPC saved 2.68% fuel in comparison to PSAT controller. Clearly by combining a prediction of the road type and congestion level with the power management strategy, fuel economy can be improved compared to the existing conventional strategy.

A neural network designed and developed for in-vehicle prediction of 11 different road types and traffic congestion levels has be described. In addition, the features and feature extraction algorithm have been described for the neural network. The two parameters, Δw (the signal window size) and Δt (the prediction step) influence the accuracy of prediction results. Simulation results using the UMD_IPC intelligent controller show that vehicle fuel consumption can be improved through the use of drive cycle and congestion level prediction. The road prediction knowledge can be applied to a hybrid vehicle power management system. This can provide significant fuel reduction in hybrid vehicle power systems.

TABLE III
PERFORMANCE COMPARISON ON FUEL CONSUMPTION

| | | Fuel Consumption | | Fuel Consumption After SOC | Saving |
|---|---|---|---|---|---|
| | Algorithm | (gram) | Final SOC (%) | correction 70% (gram) | From PSAT |
| UDDS | PSAT | 701.1821 | 65.32% | 712.5429 | |
| | Off Line DP | 700.2153 | 70.00% | 700.2153 | 1.7301% |
| | (optimal) | | | | |
| | UMD_IPC | 700.1142 | 69.96% | 700.2207 | 1.7293% |
| UNIF01 | PSAT | 1269.225 | 55.37% | 1304.799 | |
| | Off Line DP | 1268.153 | 70.00% | 1268.153 | 2.8085% |
| | (optimal) | | | | |
| | UMD_IPC | 1269.637 | 69.96% | 1269.743 | 2.6866% |
| LA92 | PSAT | 980.191 | 66.56% | 988.63 | |
| | Off Line DP | 973.428 | 70.00% | 973.42 | 1.538% |
| | (optimal) | | | | |
| | UMD_IPC | 973.3181 | 69.96% | 973.42 | 1.538% |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A system for vehicle drive cycle determination and energy control for an automotive vehicle with an engine and a storage battery, the system comprising:
a computer-readable storage medium; and
a controller in electrical communication with the storage medium, the controller being configured to receive a speed signal representing speed of the vehicle, to process the speed signal to obtain a set of features characterizing a driving environment that the vehicle has experienced, to process the features to determine a drive cycle, and to generate a control signal based on the drive cycle to control charging of the storage battery with power generated from the engine.

2. The system of claim 1 wherein the control signal is generated in an effort to decrease energy usage in the automotive vehicle.

3. The system of claim 1 wherein the control signal controls when to charge the storage battery.

4. The system of claim 1 wherein the control signal controls a rate of charging of the storage battery.

5. The system of claim 1 wherein the driving environment includes at least one road type that the vehicle has traversed.

6. The system of claim 1 wherein the driving environment includes at least one level of traffic congestion that the vehicle has experienced.

7. A system for vehicle drive cycle determination and energy control for an automotive vehicle with an engine and a storage battery, the system comprising:
a computer-readable storage medium; and
a controller in electrical communication with the storage medium, the controller being configured to receive a speed signal representing speed of the vehicle at a plurality of predetermined time segments, to process the speed signal in a sequential manner to obtain, at a predetermined time interval, a set of features characterizing a driving environment including at least one road type that the vehicle has experienced, the set of features being obtained from features stored in the computer-readable storage medium, to process the set of features to determine a road type that the automotive vehicle is predicted to traverse, to determine a drive cycle based on the road type that the automotive vehicle is predicted to traverse, and to generate a control signal based on the drive cycle to control charging of the storage battery with power generated from the engine, the control signal controlling a rate of charging of the storage battery in an effort to decrease energy usage in the automotive vehicle.

8. The system of claim 7 wherein the driving environment includes at least one level of traffic congestion that the vehicle has experienced, the controller further being configured to process the set of features to determine a level of traffic congestion that the automotive vehicle is predicted to experience and to determine the drive cycle based on the level of traffic congestion that the automotive vehicle is predicted to experience.

9. A method of drive cycle determination and energy control for an automotive vehicle with an engine and a storage battery, the method comprising:
receiving a speed signal representing speed of the vehicle;
processing the speed signal to obtain a set of features characterizing a driving environment that the vehicle has experienced;
processing the set of features to determine a drive cycle; and
generating a control signal based on the drive cycle to control charging of the storage battery with power generated from the engine.

10. The method of claim 9 wherein the driving environment includes at least one road type that the vehicle has traversed.

11. The method of claim 9 wherein the driving environment includes at least one level of traffic congestion that the vehicle has experienced.

12. The method of claim 9 wherein the set of features are obtained in a sequential manner from a predetermined set of features.

13. The method of claim 12 wherein the speed signal has a plurality of predetermined time segments and the sequential manner includes selecting one or more features from each of the time segments at a predetermined time interval.

14. The method of claim 12 wherein the sequential manner includes selecting from the predetermined set based on the driving environment that the vehicle has experienced.

15. The method of claim 9 further including using a neural network to process the set of features to determine the drive cycle.

16. The method of claim 9 wherein processing the set of features determines a road type that the automotive vehicle is predicted to traverse, the drive cycle being determined based on the road type.

17. The method of claim 9 wherein processing the set of features determines a level of traffic congestion that the automotive vehicle is predicted to experience, the drive cycle being determined based on the level of traffic congestion.

18. The method of claim 9 further including generating the control signal in an effort to decrease energy usage in the automotive vehicle.

19. The method of claim 9 further including generating the control signal to control when to charge the storage battery.

20. The method of claim 9 further including generating the control signal to control a rate of charging of the storage battery.
